(19) United States
(12) Patent Application Publication
(10) Pub. No.: US 2012/0162431 A1
(43) Pub. Date: Jun. 28, 2012

(54) METHODS AND SYSTEMS FOR MONITORING TRAFFIC FLOW

(76) Inventor: Scott Riesebosch, Ontario (CA)

(21) Appl. No.: 12/977,901

(22) Filed: Dec. 23, 2010

(51) Int. Cl. H04N 7/18

(52) U.S. Cl. 348/149; 348/E07.085

(57) ABSTRACT

In accordance with certain embodiments, a method of monitoring traffic includes capturing a plurality of time-separated images of a moving vehicle, calculating a velocity of the vehicle based on at least two of the images, and obtaining vehicle-identifying information from at least one of the images or transmitting a notification to a central location if the velocity is greater than a threshold velocity.

### FIELD OF THE INVENTION

In various embodiments, the present invention generally relates to camera-based systems for monitoring traffic flow.

### BACKGROUND

Reliable monitoring and analysis of the flow of automotive traffic is an important aspect of urban planning and development. The routings and sizes of streets and highways have a great impact on the flow of goods and workers in and out of cities, underscoring the importance of the reliability of such pathways. The safety of the public—drivers as well as pedestrians—also depends upon traffic monitoring to ensure compliance with local traffic laws. Traffic may be monitored by systems based on radar, such as automatic or officer-operated radar guns, but these may be avoided or defeated by countermeasures such as radar detectors. Laser-based systems have recently surged in popularity, but these systems are frequently expensive and require much more accurate control and user intervention to obtain reliable measurements.

In light of the foregoing, there is a need for an addressable distributed system of monitoring traffic flow and speed that requires no local operator and that is difficult to detect from the vehicles being monitored.

### SUMMARY

In accordance with certain embodiments, a traffic-monitoring system is provided. The system is preferably integrated with a group of streetlights, which provide a platform for the monitoring as well as their primary illumination function. In this manner, the monitoring system preferably utilizes existing infrastructure, obviating the need for installation of dedicated monitoring equipment along streets and highways. Each node of the monitoring system (which may be integrated on a streetlight) is preferably individually addressable from a central location and capable of sharing data with that location. Furthermore, each node preferably includes a camera to monitor traffic flow, detect speeding vehicles or slow traffic conditions, and/or count passing vehicles. The data is transmitted to the central location for analysis and/or immediate action. Preferably, the velocity of individual vehicles is solely determined by analysis of images captured by the camera, obviating the need for additional sensors such as motion sensors or radar-based systems. Thus, not only is the monitoring system less complicated and less expensive, but it is less detectable by the operators of passing vehicles (thus rendering it more resistant to countermeasures employed by such operators or vehicles). Each node may also include a second camera, preferably time-synchronized to the first camera, positioned to more easily obtain vehicle-identifying information such as license plate numbers.

In an aspect, embodiments of the invention feature a method of monitoring traffic. A plurality of time-separated images of a moving vehicle are captured, and the velocity of the vehicle is calculated based on at least two of the images. A notification is transmitted to a central location if the velocity is greater than a threshold velocity. The notification may include the calculated velocity, an image of the vehicle, and/or vehicle-identifying information obtained from at least one of the images. The notification may be transmitted without transmission (or even storage) of the images of the vehicle or any vehicle-identifying information. The plurality of images may be captured by one or more cameras mounted on one or more elevated streetlights. The threshold velocity may be changed based on driving conditions proximate the streetlight.

In another aspect, embodiments of the invention feature a method of monitoring traffic. A plurality of time-separated images of a moving vehicle are captured, the velocity of the vehicle is calculated based on at least two of the images, and a determination is made if the velocity exceeds a threshold velocity, thereby defining the vehicle as speeding. This process is repeated for a plurality of different moving vehicles, and a notification is transmitted to a central location if the number of speeding vehicles exceeds a threshold number. The notification may include the calculated velocity, an image of a vehicle, and/or vehicle-identifying information obtained from at least one of the images. The notification may be transmitted without transmission (or even storage) of the images of a vehicle or any vehicle-identifying information. The plurality of images may be captured by one or more cameras mounted on one or more elevated streetlights. The threshold velocity may be changed based on, e.g., time of day, day of the week, and/or driving conditions proximate the streetlight. The threshold number may be a function of time and/or may be changed based on, e.g., time of day, day of the week, and/or local driving conditions.

In yet another aspect, embodiments of the invention feature a method of monitoring traffic including or consisting essentially of capturing a plurality of time-separated images of a moving vehicle, calculating the velocity of the vehicle based on at least two of the images, and obtaining vehicle-identifying information from at least one of the images. In one embodiment, the vehicle-identifying information is transmitted by a first node to a first plurality of nodes geographically neighboring the first node. Detection, by any of the first plurality of (neighboring) nodes, of a vehicle conforming to the vehicle-identifying information causes the detecting node to transmit the vehicle-identifying information to a second plurality of nodes geographically neighboring the second node. This process may be repeated so that, as the vehicle is detected by a node within one of the geographically defined clusters, a new plurality of nodes geographically neighboring the detecting nodes is defined. (By “neighboring” is meant geographically proximate, e.g., the closest nodes in the four cardinal directions relative to the detecting node.) In this way, the detecting nodes indicate a trajectory of the vehicle, which may be computed geographically and extrapolated if desired. For example, based on the times of detection and the observed vehicle speed, a predicted current location can be computed.

The detecting nodes may store the vehicle-identifying information (and, if desired, the time at which the vehicle is detected) for later use and reference—rather than immediately discarding it to conserve memory resources. The detecting nodes may also or alternatively transmit the vehicle-identifying information to a central location accessible to law enforcement.

Embodiments of the invention may feature one or more of the following, in any of a variety of combinations. One or more (or even all) of the images may be transmitted to a central location, and calculating the velocity and obtaining the vehicle-identifying information may be performed at the central location. The velocity, the vehicle-identifying information, and/or the plurality of images may be transmitted to a central location. The transmission to the central location may only occur if the velocity is greater than a threshold velocity. The vehicle-identifying information may be the license plate number of the vehicle. The plurality of images may be captured by a camera mounted on an elevated streetlight, by a plurality of cameras each mounted on a different elevated streetlight, or a plurality of cameras each mounted on the same elevated streetlight.

In a further aspect, embodiments of the invention feature a traffic-monitoring system for use in connection with a camera having a shutter frequency sufficient to capture a plurality of time-separated images of a moving vehicle, including or consisting essentially of an analysis module and a reporting module. The analysis module calculates the velocity of the vehicle based on the images and/or obtains vehicle-identifying information from at least one of the images. The reporting module transmits the velocity, the vehicle-identifying information, and/or a notification to a central location. The velocity, the vehicle-identifying information, and/or the notification may be transmitted only if the analysis module determines that the velocity exceeds a threshold velocity. The analysis module may be configured to locate and identify a license plate number in at least one of the images.

In yet a further aspect, embodiments of the invention feature a monitoring system including or consisting essentially of a network server, a plurality of streetlights, and a plurality of modules for monitoring traffic flow. Each module is associated with one of the streetlights, in communication with the network server, and includes a first camera having a shutter frequency sufficient to capture a plurality of time-separated images of a moving vehicle.

Embodiments of the invention may feature one or more of the following, in any of a variety of combinations. The first camera may be disposed proximate an illumination source of the streetlight. Each module may include a second camera disposed below the first camera, and the first and second cameras may be time-synchronized. Each module may have a unique address addressable by the network server. Each streetlight may include at least one light-emitting diode and may emit substantially white light. Each module may include an analysis module for calculating the velocity of the vehicle based on the images and/or obtaining vehicle-identifying information from at least one of the images, as well as a reporting module for transmitting the velocity, the vehicle-identifying information, and/or a notification to the central location. The velocity, the vehicle-identifying information, and/or the notification may be transmitted only if the analysis module determines that the velocity exceeds a threshold velocity. The analysis module may be configured to locate and identify a license plate number in at least one of the images.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. As used herein, the term “substantially” means±10%, and in some embodiments, ±5%.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a block diagram of the components of a monitoring system in accordance with various embodiments of the invention;

FIG. 2 is a perspective view of a node of the monitoring system illustrated in FIG. 1, in accordance with various embodiments of the invention;

FIG. 3 is a block diagram of the components of a monitoring module of the node depicted in FIG. 2, in accordance with various embodiments of the invention; and

FIGS. 4A, 4B, and 4C depict exemplary images utilized to determine vehicular velocity and vehicle-identifying information in accordance with various embodiments of the invention.

### DETAILED DESCRIPTION

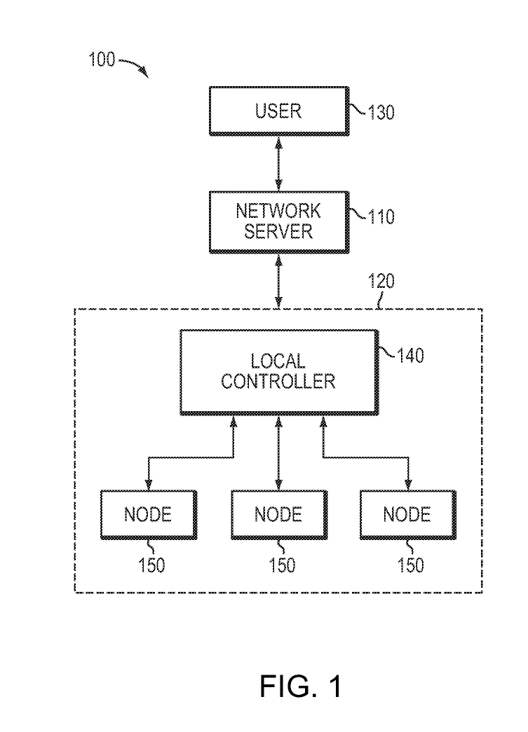

With reference to FIG. 1, a monitoring system 100 in accordance with various embodiments of the invention includes a network server 110, one or more networks 120 in communication with network server 110, and one or more users 130 who input commands and/or receive output data from network server 110. As shown, each network 120 includes or consists essentially of a local controller 140 and multiple networked nodes 150. Each node 150 is preferably integrated with an elevated streetlight, and at least a portion of the node 150 (e.g., a camera) is typically at the height of the illumination source. As used herein, the term “streetlight” includes fixtures for road illumination as well as for traffic signaling, and the term “street” includes roads, highways, and other thoroughfares.

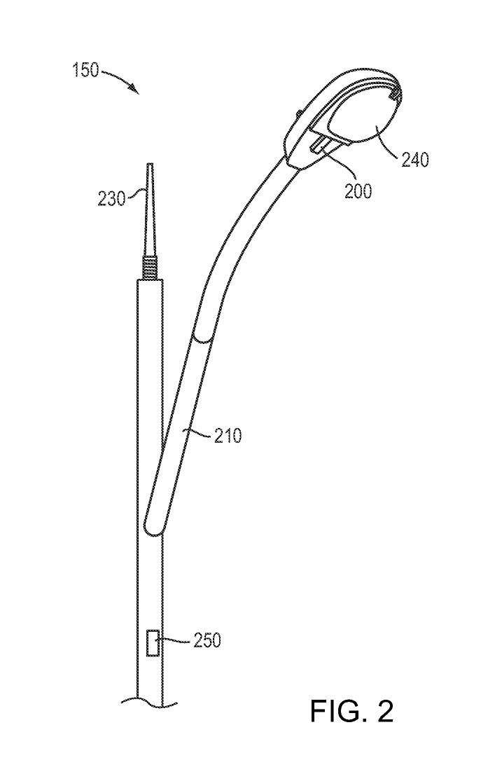

A node 150 includes or consists essentially of a camera for determining, e.g., the velocity of vehicles passing the streetlight, associated electronics for sending, receiving, and storing data, image recognition, and computation, as detailed below with reference to FIG. 2. The node 150 may also include an optional second camera, typically positioned well below the illumination source (i.e., closer to street level), for obtaining vehicle-identifying information such as license plate numbers, make and/or model information, vehicle color, and/or other identifiable characteristics (e.g., presence or absence of such features as a sunroof, moonroof, spoiler, etc.), particularly if such information is not obtainable by the primary camera. As utilized herein, a node 150 consisting essentially of one or more cameras may include the types of electronics described above, but does not include additional sensors or sensor systems for tracking motion, e.g., motion sensors and/or radar systems. Each node 150 may receive operational commands from local controller 140, which in turn sends and receives commands and data relevant to nodes 150 in network 120 from network server 110. In alternate embodiments, local controller 140 is omitted from network 120, and each node 150 communicates directly with network server 110.

The nodes 150 of network 120 monitor the flow and velocity of vehicular traffic on nearby street(s). FIG. 2 depicts an exemplary node 150, in which a monitoring module 200 is integrated with a streetlight 210. Streetlight 210 preferably overlooks a street, and preferably affords a view of passing vehicular traffic to module 200. Node 150 may also include an antenna 230 integrated with streetlight 210 in order to facilitate wireless communication (e.g., based on the IEEE 802.11 standard or a cellular link) between module 200 and local controller 140 and/or network server 110. The module 200 typically includes a camera (as detailed below), and is preferably positioned near an illumination source 240 of streetlight 210. Optionally, each node 150 includes a camera 250 positioned closer to street level to facilitate the capture of vehicle-identifying information such as license plate numbers. Although in FIG. 2 camera 250 is shown as separate from module 200, in various embodiments camera 250 may be considered a portion of the monitoring module 200. Similarly, various other components associated with module 200 (as detailed below) may be integrated within an integrated “module” or positioned elsewhere in node 150, e.g., on or near streetlight 210.

Streetlight 210 may emit substantially white light (and/or light of other predetermined colors) via illumination source 240, which may include or consist essentially of, e.g., one or more incandescent bulbs, fluorescent bulbs, or light-emitting diodes (LEDs). For example, streetlight 210 may incorporate multiple white LEDs (i.e., LEDs having a colored output that mixes with a phosphor to produce a white output) or a combination of colored LEDs (e.g., red, green, and blue) whose emitted light mixes to form substantially white light. In some embodiments, operation of streetlight 210 may also be controlled from network server 110 and/or local controller 140 via, e.g., signals sent to antenna 230. For examples, commands to begin or cease illumination, illuminate in a time-varying pattern, and/or to alter the emitted illumination color may be sent to streetlight 210.

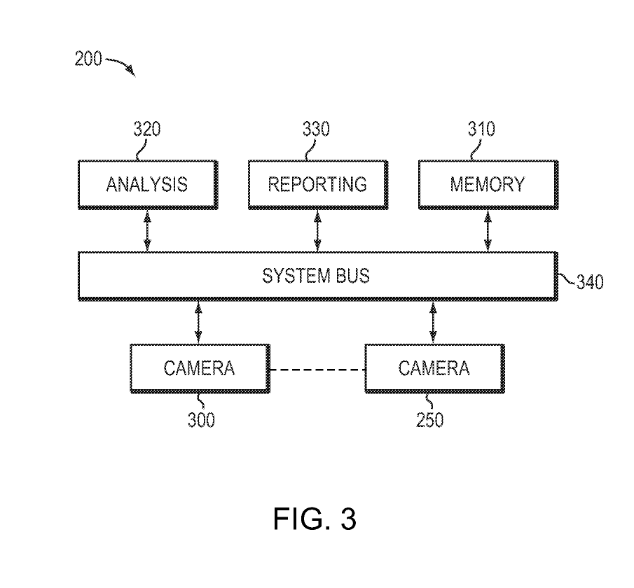

FIG. 3 depicts various components that may be associated with each monitoring module 200. Each module 200 typically includes a camera 300 that is positioned to view and capture images of vehicular traffic passing near streetlight 210, and may include the above-described camera 250 that is positioned to facilitate the capture of vehicle-identifying information such as license plate numbers. Cameras 250, 300 may be either still-image cameras or video cameras, and typically each has a shutter frequency sufficient to capture multiple time-separated images of a moving vehicle. In preferred embodiments (and as denoted by the dashed connecting line in FIG. 3), cameras 250, 300 are time-synchronized, i.e., capture images at substantially the same times. In this way, vehicle-identifying information for a particular vehicle may be associated with, e.g., that vehicle's velocity calculated based on the images (as detailed below).

Module 200 may also include a memory 310, an analysis module 320, and/or a reporting module 330. The components of module 200 communicate over a system bus 340. Still or video images (which may be considered to be a series of still images taken at short time intervals) of passing traffic may be stored in memory 310 and/or transmitted to the network server 110 (via reporting module 330) for further action. Analysis module 320 may be utilized to recognize images of passing vehicles (and/or their license plate numbers via optical character recognition) and/or compute the velocity thereof, as detailed below. In some embodiments, analysis module 320 is physically present in module 200, and the functionality of analysis module 320 is provided at the local controller 140 and/or the network server 110. In such cases, module 200 may simply acquire and/or store images and transmit them via reporting module 330 (e.g., utilizing antenna 230). Each module 200 may have a unique address, e.g., an internet protocol (IP) address, that is addressable via the network server 110 and/or local controller 140.

Although the modules in module 200 (as well as the other components of monitoring system 100) have been described separately, this is for clarity of presentation only. As long as monitoring system 100 performs all necessary functions, it is immaterial how they are distributed therewithin and the programming or hardware architecture thereof. Furthermore, the above-described implementation is exemplary only. Other hardware approaches are possible, e.g., the various modules of embodiments of the invention may be implemented on a general-purpose computer programmed with appropriate software instructions implementing the functions described below, or as hardware circuits (e.g., as an application-specific integrated circuit, or ASIC), or as mixed hardware-software combinations.

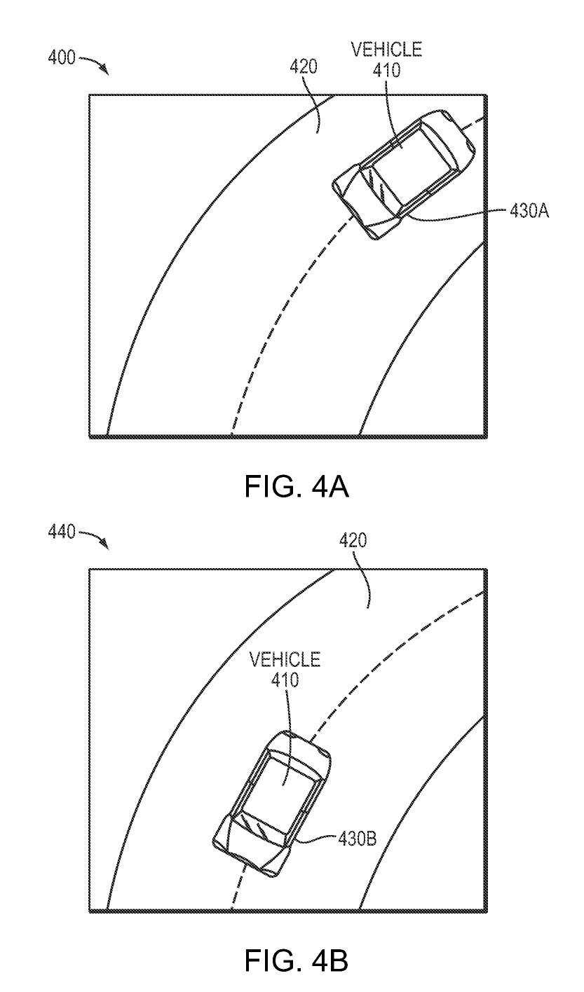

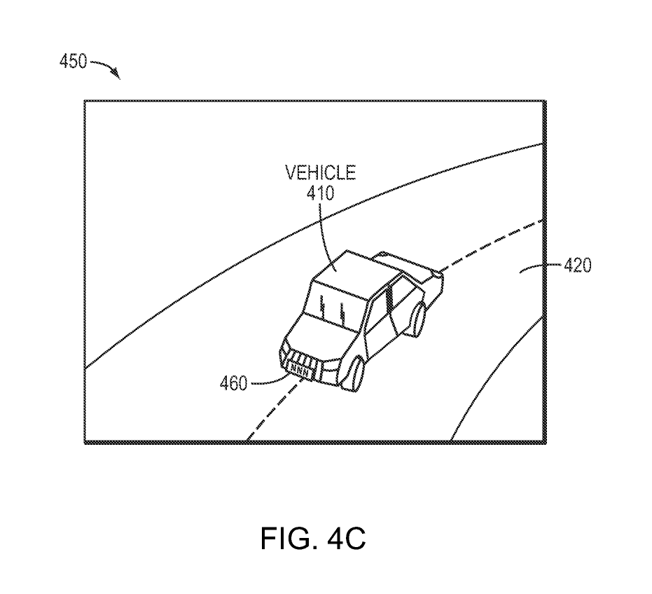

The integration of modules 200 (each of which may include or consist essentially of one or more cameras 300, 250) with streetlights 210 facilitates the determination of velocity of passing vehicles, as illustrated in FIGS. 4A and 4B. FIG. 4A depicts an image 400 of a vehicle 410 travelling on a street 420 near a node 150. Image 400 is captured by camera 300, and may be a discrete still image or a still-image portion of a video stream. Image 400 depicts vehicle 410 in a first position 430A. Depending on the angle of camera 300 relative to vehicle 410, image 400 may also include vehicle-identifying information, such as the license plate number of vehicle 410, which in turn may optionally be recognized by analysis module 320 via, e.g., optical character recognition. In other embodiments, such vehicle-identifying information is not captured in and/or derived from image 400, but is instead captured by camera 250 in an image time-synchronized to image 400 (as further described below).

FIG. 4B depicts an image 440 of the vehicle 410 on street 420 in a second position 430B. As described above regarding image 400, image 440 may be a discrete still image or a still-image portion of a video stream captured by a camera 300. Images 400 and 440 are taken at a known time interval therebetween, and the velocity of vehicle 410 is computed (e.g., by analysis module 320 or remotely at network server 110 or local controller 140) by, e.g., dividing the change in position (i.e., the quantitative difference between positions 430B and 430A) by the time interval between images 400 and 440. Analysis module 320 identifies vehicle 410 as the same vehicle in images 400, 440 via, e.g., pattern-recognition techniques known to those of skill in the art; in particular, it is trivial to segregate images of the same vehicle as it travels across the field of view from images of the next or preceding vehicle. And, just as described for image 400, image 440 may include vehicle-identifying information. Vehicle images may be discarded instantly or on a rolling basis to conserve memory resources, but images of speeding vehicles may be retained for reference or evidentiary purposes.

Images 400, 440 may both be acquired by the same camera 300 at a single node 150, or they may each be captured by different cameras 300 at different nodes 150. For example, images 400, 440 may be taken by cameras 300 at neighboring streetlights 210, and the difference in positions 430B and 430A includes the known distance between the two streetlights 210. In any case, because computation of the velocity of vehicle 410 does not involve radar, laser detection, or other types of motion sensors, monitoring system 100 is more difficult to evade by vehicular operators. Although in some embodiments the placement of nodes 150 and/or cameras 300 may be known to vehicular operators (who may adjust the velocity of vehicles 410 accordingly near such known locations), integration of monitoring modules 200 with streetlights 210 enables the computation of an average velocity of a vehicle 410 over a long distance, as long as at least two nodes 150 of system 100 are present along that distance. Thus, even if the velocity of a vehicle 410 near the node(s) 150 is below a particular threshold (as also detailed below), the average velocity of the vehicle between the nodes 150 may be straightforwardly calculated by system 100 and may be above that threshold.

As mentioned above, camera 250 may also capture one or more images of vehicle 410 that are time-synchronized to either image 400 or image 440. The different vantage point of camera 250 may facilitate the capture and recognition of vehicle-identifying information, such as the license plate number, of vehicle 410. Even though cameras 250 and 300 capture images from different physical locations, the synchronization between the images facilitates their association with the same vehicle 410. FIG. 4C depicts an exemplary image 450 as captured by camera 250 depicting vehicle 410 on street 420. License plate 460 is visible in image 450 and may be recognized by a conventional pattern-recognition technique known in the art, enabling the identification thereof by analysis module 320 by, e.g., optical character recognition. Other vehicle-identifying information that may be captured by cameras 250, 300 and/or analyzed by analysis module 320 includes the color(s) (or a predominant color) of vehicle 410, its make, or its model type, among others listed above. Image 450 is preferably synchronized with one of images 400, 440, i.e., vehicle 450 is in one of positions 430A, 430B in image 450.

As mentioned above, images 400, 440, 450 may be transmitted to network server 110 and/or local controller 140 for further action (e.g., velocity computation), and/or the velocity of vehicle 410 may be computed at node 150 (i.e., by analysis module 320) and transmitted to network server 110 and/or local controller 140. In some embodiments, the velocity of vehicle 410 is computed at node 150 but transmitted to network server 110 and/or local controller 140 only if the computed velocity is greater than a threshold velocity, e.g., the posted speed limit of the thoroughfare at the position of node 150. In some embodiments, the threshold velocity is slightly higher than the local posted speed limit by, e.g., 5-10 miles per hour. One or more threshold velocities may be stored at each node 150 (e.g., within memory 310), and may be updated via communications with network server 110 and/or local controller 140. For example, the threshold velocity may be increased or decreased depending upon driving conditions on street 420, e.g., the presence of construction work, the presence of a safety hazard, weather conditions, etc. Once the velocity and/or image(s) of vehicle 410 are transmitted to network server 110 and/or local controller 140, they may be further processed, e.g., transmitted to law-enforcement authorities for imposition of a monetary fine.

In some embodiments, once a vehicle 410 has been identified by one or more nodes 150 (for, e.g., exceeding the threshold velocity), the vehicle-identifying information related to the vehicle 410 is transmitted over the network 120 to at least one other node 150. For example, since the direction of travel of vehicle 410 may be derived from the images captured at a node 150, the vehicle-identifying information may be transmitted to the neighboring one or more nodes 150 in that direction. Once images of the vehicle 410 are captured at the other node(s), vehicle-identifying information captured at the other node(s) may be matched to the transmitted information such that the location and/or trajectory of an identified vehicle 410 may be tracked node-to-node. Images of a “tagged” vehicle obtained at the various nodes may be retained, as noted above, for evidentiary or other purposes. The location and/or trajectory of the identified vehicle 410 may also be transmitted to a central location, e.g., network server 110 and/or local controller 140, for, e.g., further transmittal to (or access by) relevant law-enforcement authorities.

In various embodiments, specific vehicles are not identified via, e.g., the transmission of vehicle-identifying information, and instead, a notification is transmitted to network server 110 and/or local controller 140 if the computed velocity of vehicle 410 (or of a specified minimum threshold number of vehicles 410) exceeds the threshold velocity. In this manner, general traffic conditions may be reported without identifying specific vehicles. The minimum threshold number of speeding vehicles 410 prompting the notification may be a function of time, i.e., may require detection of a minimum number of speeding vehicles 410 exceeding the threshold velocity within a specified time period, e.g., an hour or fraction thereof. The notification may be, e.g., an e-mail or other message to user 130, and may originate at node 150, network server 110, and/or local controller 140. For example, the notification may originate at the location of velocity computation.

In some embodiments, the functionality of monitoring system 100 and nodes 150 may be integrated into a series of streetlights that already have cameras integrated therewith (particularly if those cameras have shutter speeds sufficient to capture multiple time-separated images of a nearby moving vehicle). For example, a node 150 may include a standalone module 200, integrated with such a streetlight, that contains only analysis module 320, reporting module 330, and/or memory 310. In this manner, the functionality of preinstalled traffic-camera systems is enhanced.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of monitoring traffic, the method comprising:
capturing a plurality of time-separated images of a moving vehicle;
calculating a velocity of the vehicle based on at least two of the images; and
transmitting a notification to a central location if the velocity is greater than a threshold velocity.

2. The method of claim 1, wherein the notification is transmitted without transmission of an image of the vehicle to the central location.

3. The method of claim 1, wherein the plurality of images is captured by a camera mounted on an elevated streetlight.

4. The method of claim 3, further comprising changing the threshold velocity based on driving conditions proximate the streetlight.

5. The method of claim 1, wherein the plurality of images is captured by a plurality of cameras, each camera being mounted on a different elevated streetlight.

6. The method of claim 1, wherein the plurality of images is captured by a plurality of cameras, each camera being mounted on the same elevated streetlight.

7. A method of monitoring traffic, the method comprising:
(a) capturing a plurality of time-separated images of a moving vehicle;
(b) calculating a velocity of the vehicle based on at least two of the images;
(c) determining if the velocity exceeds a threshold velocity, thereby defining the vehicle as speeding;
(d) repeating steps (a) through (c) for a plurality of different moving vehicles; and
(e) transmitting a notification to a central location if a number of speeding vehicles exceeds a threshold number.

8. The method of claim 7, wherein the plurality of images is captured by a camera mounted on an elevated streetlight.

9. The method of claim 8, further comprising changing the threshold velocity based on driving conditions proximate the streetlight.

10. The method of claim 7, wherein the threshold number is a function of time.

11. A method of monitoring traffic, the method comprising:
capturing a plurality of time-separated images of a moving vehicle;
calculating a velocity of the vehicle based on at least two of the images; and
obtaining vehicle-identifying information from at least one of the images.

12. The method of claim 11, further comprising transmitting the plurality of images to a central location, wherein calculating the velocity and obtaining the vehicle-identifying information are performed at the central location.

13. The method of claim 11, further comprising transmitting at least one of the velocity, the vehicle-identifying information, or the plurality of images to a central location.

14. The method of claim 13, wherein transmission to the central location occurs only if the velocity exceeds a threshold velocity.

15. The method of claim 11, wherein the vehicle-identifying information is obtained by a first node of a traffic-monitoring system, and further comprising transmitting the vehicle-identifying information to a second node of the traffic-monitoring system, the second node being different from the first node.

16. The method of claim 15, wherein the vehicle-identifying information is transmitted by the first node to a first plurality of nodes geographically neighboring the first node, whereupon detection, by any of the first plurality of nodes, of a vehicle conforming to the vehicle-identifying information causes the detecting node to transmit the vehicle-identifying information to a second plurality of nodes geographically neighboring the second node.

17. The method of claim 16, wherein the first node and the detecting node store the vehicle-identifying information.

18. The method of claim 17, wherein the first node and the detecting node transmit the vehicle-identifying information to a central location accessible to law enforcement.

19. The method of claim 18, further comprising computing a trajectory of the detected vehicle based on geographical locations of the first node and the detecting node.

20. The method of claim 18, further comprising recording the times at which the vehicle is detected by the first node and the detecting node.

21. The method of claim 11, wherein the vehicle-identifying information is a license plate number of the vehicle.

22. The method of claim 11, wherein the plurality of images is captured by a camera mounted on an elevated streetlight.

23. The method of claim 11, wherein the plurality of images is captured by a plurality of cameras, each camera being mounted on a different elevated streetlight.

24. The method of claim 11, wherein the plurality of images is captured by a plurality of cameras, each camera being mounted on the same elevated streetlight.

25. A traffic-monitoring system for use in connection with a camera having a shutter frequency sufficient to capture a plurality of time-separated images of a moving vehicle, the system comprising:
an analysis module for calculating a velocity of the vehicle based on the images and obtaining vehicle-identifying information from at least one of the images; and
a reporting module for transmitting the velocity and vehicle-identifying information to a central location.

26. The system of claim 25, wherein the velocity and vehicle-identifying information are transmitted only if the analysis module determines that the velocity exceeds a threshold velocity.

27. The system of claim 25, wherein the analysis module is configured to locate and identify a license plate number in at least one of the images.

28. A monitoring system comprising:
a network server;
a plurality of streetlights;
a plurality of modules for monitoring traffic flow, each module (i) being associated with one of the streetlights, (ii) being in communication with the network server, and (iii) comprising a first camera having a shutter frequency sufficient to capture a plurality of time-separated images of a moving vehicle.

29. The monitoring system of claim 28, wherein the first camera is disposed proximate an illumination source of the streetlight.

30. The monitoring system of claim 29, wherein each module comprises a second camera disposed below the first camera, the first camera and the second camera being time-synchronized.

31. The monitoring system of claim 28, wherein each module has a unique address addressable by the network server.

32. The monitoring system of claim 28, wherein each streetlight comprises at least one light-emitting diode and emits substantially white light.

33. The monitoring system of claim 28, wherein each module comprises (i) an analysis module for calculating a velocity of the vehicle based on the images and obtaining vehicle-identifying information from at least one of the images, and (ii) a reporting module for transmitting the velocity and vehicle-identifying information to the central location.

34. The monitoring system of claim 33, wherein the velocity and vehicle-identifying information are transmitted only if the analysis module determines that the velocity exceeds a threshold velocity.

35. The monitoring system of claim 33, wherein the analysis module is configured to locate and identify a license plate number in at least one of the images.
